(19) United States
(12) Patent Application Publication
(10) Pub. No.: US 2019/0084159 A1
(43) Pub. Date: Mar. 21, 2019

(54) MOBILE UNIT

(71) Applicant: PANASONIC CORPORATION, Osaka (JP)

(72) Inventors: Noriaki Imaoka, Osaka (JP); Takeshi Ando, Kyoto (JP)

(21) Appl. No.: 16/131,263

(22) Filed: Sep. 14, 2018

(30) Foreign Application Priority Data
Sep. 21, 2017 (JP) 2017-181677
Jun. 28, 2018 (JP) 2018-122683

(51) Int. Cl. B25J 9/16

(52) U.S. Cl. CPC B25J 9/1679

(57) ABSTRACT

A mobile unit which suppresses an increase in weight and/or costs and/or a decrease in reliability is disclosed. In a mobile unit capable of turning movement, a right-hand part and a left-hand part are involute shaped, and a center point of a base circle of the involute shape passes through at least one axis among center axes of turning movement.

### CROSS REFERENCE TO RELATED APPLICATIONS

This application is entitled to and claims the benefit of Japanese Patent Application No. 2017-181677, filed on Sep. 21, 2017, and Japanese Patent Application No. 2018-122683, filed on Jun. 28, 2018, the disclosure of which including the specifications, drawings and abstracts are incorporated herein by reference in their entirety.

### TECHNICAL FIELD

The present invention relates to an autonomous mobile unit.

### BACKGROUND ART

Traditionally, an autonomous robot (an example of a mobile unit) moves while determining a path so as not to be in contact with a human. When a robot moves in a crowd, there is a high possibility that a robot and a human make contact with each other, however. Therefore, there is a concern that a robot cannot efficiently perform a task of the robot.

In this respect, Non-Patent Literature (hereinafter, referred to as “NPL”) 1 describes a method of efficiently performing a task even in a crowd by causing a robot to proactively make contact with a human to prompt the human to clear the way for the robot.

In NPL 1, robot arms of two degrees of freedom are mounted by a double arm, and when there is no path allowing the robot to move without making contact with a human, the robot itself performs an operation to contact a single arm with a human for the human to clear the way for the robot. As described, by causing the robot to make contact with a human, there will be more paths through which the robot can move, and the efficiency of performing tasks can be enhanced because of the robot passing through the paths.

### CITATION LIST

### Patent Literatures

NPL 1
Moondeep C. Shretha et al., “Using Contact-based Inducement for Efficient Navigation in a Congested Environment,” Robot and Human Interactive Communication, Aug. 31-Sep. 4. 2015

### SUMMARY OF INVENTION

### Technical Problem

The robot disclosed in NPL 1 includes robot arms of two degrees of freedom mounted by a double arm because a contact direction for prompting a human to clear the way needs to be controlled. When double arms of robot arms of two degrees of freedom are mounted on a robot, there arises a concern that the weight and/or costs of the robot may increase and/or reliability may decrease due to an increase in the number of parts.

The present invention is to solve the traditional problem described above and thus aims at providing a mobile unit with which an increase in weight and/or costs and a decrease in reliability can be suppressed.

### Solution to Problem

To achieve the above object, a mobile unit of the present invention is capable of turning movement and includes: an involute shape on an outer side surface of the mobile unit, in which a center point of a base circle of the involute shape passes through at least one axis among center axes of the turning movement.

### Advantageous Effects of Invention

According to the present invention, an increase in weight and/or costs and a decrease in reliability can be suppressed.

### BRIEF DESCRIPTION OF DRAWINGS

FIG. 1 is an exterior perspective view of a configuration of a mobile unit according to an embodiment of the present invention;

FIG. 2 is an explanatory diagram schematically illustrating a state of the mobile unit according to the embodiment as viewed from straight above, and illustrating an example of a contact method of the mobile unit;

FIG. 3 is another explanatory diagram schematically illustrating a state of the mobile unit according to the embodiment as viewed from straight above, and illustrating an example of the contact method of the mobile unit;

FIG. 4 is a flowchart relating to behavior of the the mobile unit according to the embodiment; and

FIG. 5 is a flowchart relating to a prompt method of the mobile unit in the embodiment.

### DESCRIPTION OF EMBODIMENTS

Hereinafter, a description will be given of each embodiment of the present invention with reference to the accompanying drawings. Note that, the same reference numerals are assigned to the same components throughout the drawings. Further, each of the drawings is a schematic illustration with each configuration element as a main subject of the illustration for easier understanding.

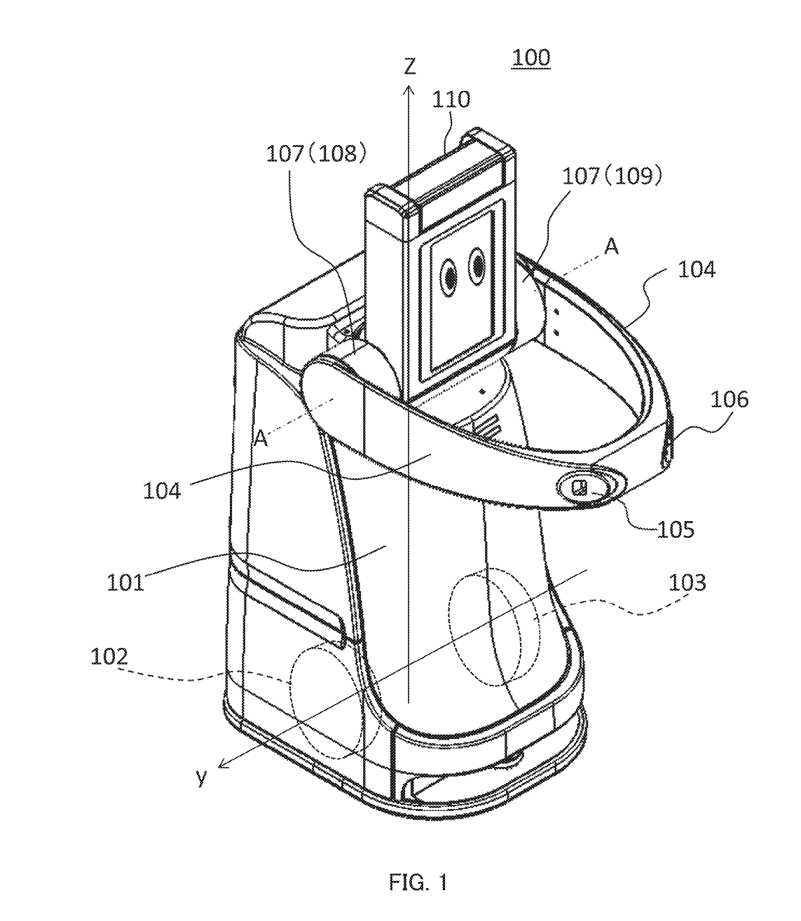

FIG. 1 is an exterior perspective view illustrating an overview of a configuration of mobile unit 100 according to the present embodiment.

Mobile unit 100 is an autonomous mobile unit. As illustrated in FIG. 1, mobile unit 100 includes: body 101; right driving section 102 and left driving section 103 which move body 101; arm parts 104 extending in a forward direction from right and left positions in a width direction of mobile unit 100; right-hand part 105 and left-hand part 106 which are provided in a forward direction of arm parts 104; shoulder parts 107 (e.g., right-shoulder part 108 and left-shoulder part 109) which can raise or lower arm parts 104 (e.g., right-hand part 105 and left-hand part 106); and surrounding object recognition part 110.

Body 101 is a main body of mobile unit 100 and is capable of moving using right driving section 102 and left driving section 103. Right driving section 102 and left driving section 103 are wheels independently rotatable about the same axis (y-axis illustrated in FIG. 1), respectively. Mobile unit 100 moves straight forward or moves while turning around by rotating these two wheels (right driving section 102 and left driving section 103), using an electric motor (illustration is omitted). Note that, the y-axis illustrated in FIG. 1 is a straight line parallel to the width direction of the mobile unit 100.

Arm parts 104 are shaped to extend in the forward direction of the right-left positions (shoulders 107) of the width direction of body 101 and combined at a center portion of the width direction of mobile unit 100 by right-hand part 105 and left-hand part 106 in leading ends of arm parts 104 in the forward direction.

The outer-side shapes of right-hand part 105 and left-hand part 106 are involute shapes each having a center point on a plane which passes through the rotation axis of right driving section 102 and left driving section 103 and which is perpendicular to the ground. More specifically, describing with reference to FIG. 1, in a case where the rotation axis of right driving section 102 and left driving section 103 is set to the y-axis whereas a straight line passing through an intermediate position between right driving section 102 and left driving section 103 on the y-axis and standing perpendicular to the ground is set to a z-axis, right-hand part 105 and left-hand part 106 each have an involute shape having a center point on a y-z plane.

The positions of right-hand part 105 and left-hand part 106 in the forward and backward direction and a height direction (up and down direction) are adjusted using shoulder parts 107 provided at the bases of arm parts 104. Shoulder parts 107 include right-shoulder part 108 and left-shoulder part 109.

Right-shoulder part 108 and left-shoulder part 109 are connected to body 101 via a rotation shaft (A-axis illustrated in FIG. 1) parallel with the width direction of mobile unit 100. Rotation shaft A is connected to an output shaft of an electric motor (illustration is omitted). Right-shoulder part 108 and left-shoulder part 109 rotate about the rotation shaft by driving of the electric motor. Thus, arm parts 104 connected to right-shoulder part 108 and left-shoulder part 109 operate in an up direction or a down direction and operate to raise or lower right-hand part 105 and left-hand part 106.

Surrounding object recognition part 110 is capable of measuring a position and a shape of a surrounding object. For example, a range image sensor can be used as surrounding object recognition part 110, but surrounding object recognition part 110 is not limited to this, and a monocular camera, a stereo camera, or a laser scan sensor may be used. In the case where a monocular camera, a stereo camera, or a laser scan sensor is used, effects of reducing costs, and/or recognition accuracy enhancement, and/or the like can be obtained.

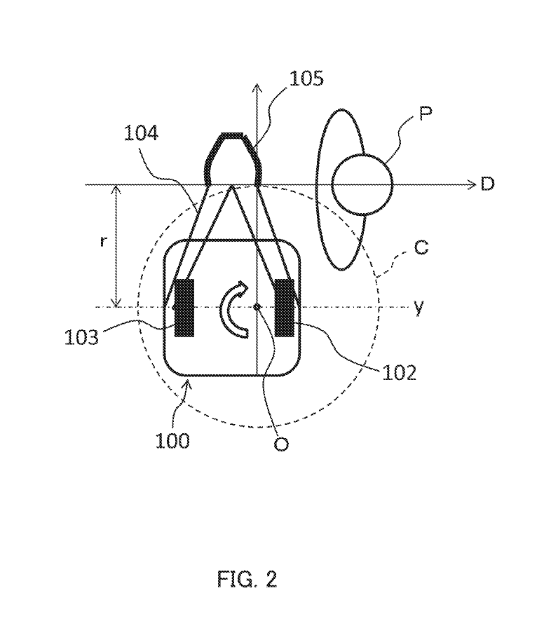

Details of the involute shape and a contact method of mobile unit 100 will be described using FIG. 2.

FIG. 2 is an explanatory diagram schematically illustrating a state of mobile unit 100 as viewed from straight above, and illustrating an example of the contact method of mobile unit 100.

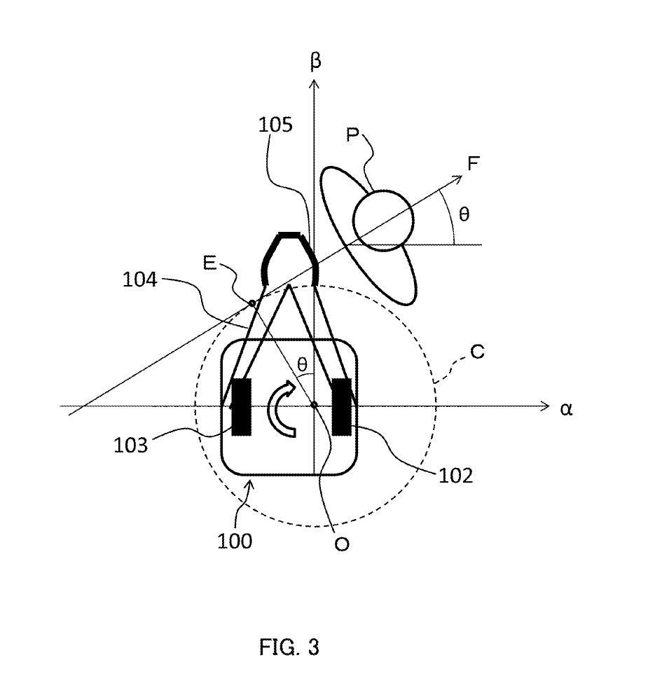

Although right-hand part 105 and left-hand part 106 are provided with the involute shapes of different center points, respectively, in the following description, using FIG. 2, which illustrates only right-hand part 105, a description will be given of the details of the involute shape of right-hand part 105 and the contact method (the same applies to FIG. 3).

As illustrated in FIG. 2, involute center point O of right-hand part 105 (center point O of base circle C of the involute shape) exists on rotation axis-y of right driving section 102 and the left driving section 103, when mobile unit 100 is viewed from straight above. Further, when the radius of base circle C of the involute shape of right-hand part 105 is set to r, mobile unit 100 can generate, by turning about center point O, using right driving section 102 and left driving section 103 (by turning about, as the center axis, an axis passing through center point O and being perpendicular to the ground), a contact force in an immediately lateral direction (direction indicated by arrow D) with respect to contact target P (e.g., human) present at a position distant from rotation axis-y of right driving section 102 and left driving section 103 by distance r as illustrated in FIG. 2.

Hypothetically, when right-hand part 105 is not an involute shape in FIG. 2, pushing contact target P by causing mobile unit 100 to turn alone results in changing the direction in which the contact force is generated to the turning direction when contact target P moves. Meanwhile, since right-hand part 105 has an involute shape in this embodiment, even when contact target P moves to the direction in which the contact force is generated, the contact force in the same direction can be always generated. Therefore, contact target P can be pushed in the same direction.

As the parameters for determining the involute shape mentioned above, two parameters, namely, radius r of base circle C and the position of center point O, can be mentioned.

Radius r of base circle C preferably puts a constant space as the distance between contact target P and mobile unit 100, and according to a result of a trial and error experiment conducted by the inventor of the present application, it is favorable to set a distance such that mobile unit 100 makes contact with contact target P at a distance of 30 cm to 50 cm from a front part of mobile unit 100.

Moreover, since the position of center point O also serves as a center position of turning of mobile unit 100, it is preferable that the position of center point O be as close as possible to the center position of mobile unit 100 in order that the motion of mobile unit 100 when making contact with contact target P cannot be large, and it is favorable to set a turning radius at least smaller than mobile unit 100. Therefore, center point O of the involute shape of right-hand part 105 is favorably positioned between the center of mobile unit 100 and right driving section 102. Moreover, center point O of the involute shape of left-hand part 106 is favorably positioned between the center of mobile unit 100, and left driving section 103.

Note that, in the present embodiment, the involute shape can generate a contact force not only in an immediately lateral direction but also in any direction. A specific example of this will be described using FIG. 3.

As with FIG. 2, FIG. 3 is an explanatory diagram schematically illustrating a state of mobile unit 100 according to the embodiment as viewed from straight above, and illustrating an example of the contact method of mobile unit 100.

Hereinafter, a description will be given of a case where mobile unit 100 makes contact with target object P tilted at angle θ with respect to the immediately lateral direction (width direction) of mobile 100, using FIG. 3. Note that, the state illustrated in FIG. 2 corresponds to a state when angle θ illustrated in FIG. 3 is zero.

First, as illustrated in FIG. 3, as a coordinate system, the rotation axis (y-axis illustrated in FIG. 1 and FIG. 2) of right driving section 102 and left driving section 103 is set to a-axis, whereas a line passing through involute center point O of right-hand part 105 and being perpendicular to α-axis is set to β-axis.

Moreover, an involute curve is a curve which can make a tangent drawn from any point on base circle C of an involute curve to be a line of action by turning about involute center point O.

Therefore, in order to generate a contact force in the direction of angle θ with respect to contact target P, contact target P just needs to be present on tangent F passing through tangent point E and tilted at angle θ with respect to β-axis on base circle C of the involute shape on a right side of arm 104. More specifically, when mobile unit 100 moves such that contact target P is present on coordinates (α, β) which satisfy β=tan θ×α+r/cos θ, it becomes possible to always contact in the direction of angle θ (the direction of tangent F becomes the direction in which a contact force is generated).

Note that, FIG. 3 illustrates, as an example, a case where contact target P is present on the right-hand side of mobile unit 100, and when contact target P is present on the left-hand side of mobile unit 100, contact is made using left-hand part 106.

Since the involute shape of each of right-hand part 105 and left-hand part 10 becomes a shape extending in the forward direction of mobile unit 100, there is no problem when contact is made to a contact target around mobile unit 100, but a large space is required when mobile unit 100 is caused to turn around without making any contact with an object around mobile unit 100.

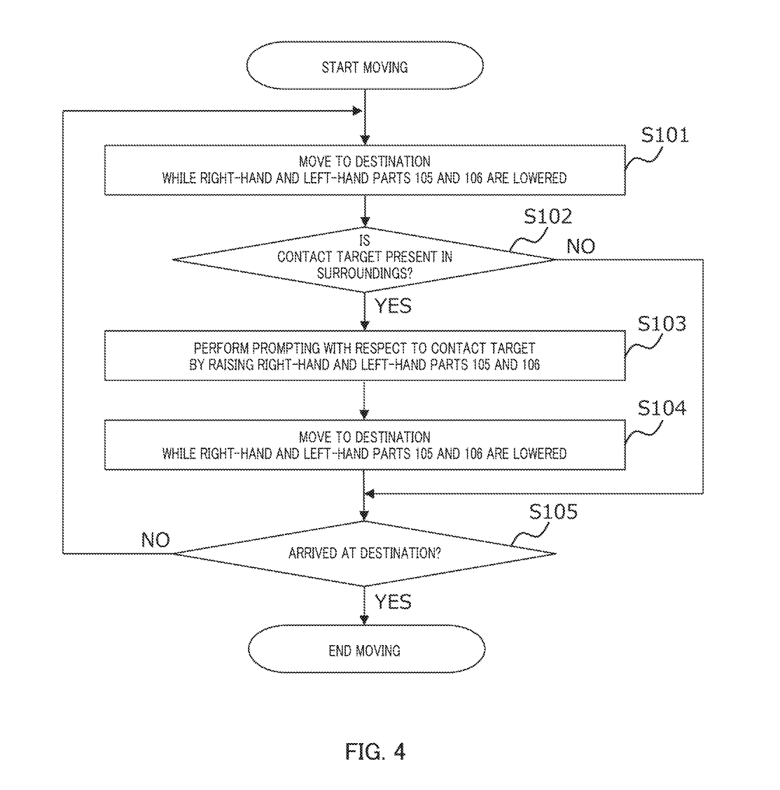

In this respect, turning around without requiring a large space in a case where no contact target is present around mobile unit 100 is made possible by pulling right-hand part 105 and left-hand part 106 in a direction closer to mobile unit 100 while directing the involute shapes of right-hand part 105 and left-hand part 106 to the lower direction or the upper direction. Specific behavior of mobile unit 100 will be described using a flowchart of FIG. 4.

The flow illustrated in FIG. 4 is implemented by a control of a control apparatus (illustration is omitted) provided inside or outside of mobile unit 100, for example. The control apparatus controls an up and down operation of right-hand part 105 and left-hand part 106 and/or autonomous movement of mobile unit 100 (such as straight forward movement and/or turning movement, for example).

First, mobile unit 100 starts moving to a designated destination in a state where right-hand part 105 and left-hand part 106 are lowered (step S101).

Next, mobile unit 100 checks whether or not a contact target is present around mobile unit 100, using a sensor capable of detecting a contact target (e.g., infrared sensor) and/or the like (step S102).

When no contact target is present (step S102: NO), the flow advances to step S105 to be described, hereinafter.

Meanwhile, when a contact target is present (step S102: YES), mobile unit 100 starts prompting with respect to the contact target by raising right-hand part 105 and left-hand part 106 (step S103).

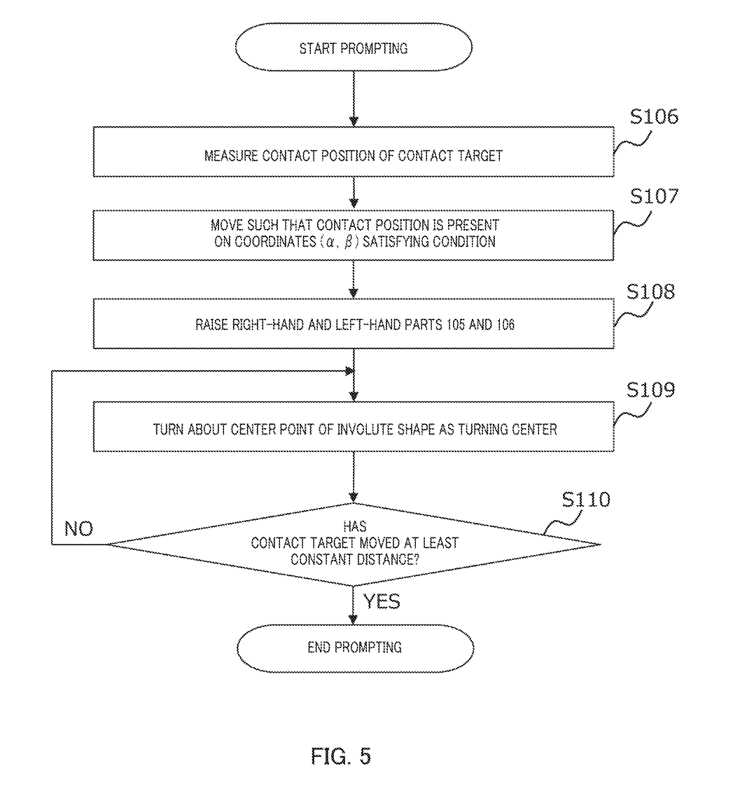

Hereinafter, a prompting method with respect to a contact target will be described in detail using a flowchart of FIG. 5.

First, mobile unit 100 measures a contact position of the contact target, using surrounding object recognition part 110 (step S106).

Next, mobile unit 100 moves such that the measured contact position is present on coordinates (α, β) satisfying a predetermined condition (e.g., β=tan θ×α+r/cos θ) (step S107). At this time, θ is a contact direction to the contact target and is determined corresponding to the direction in which the contact target is moved.

Then, mobile unit 100 raises right-hand part 105 and left-hand part 106 (step S108) and performs turning movement about a center point of the involute shape of right-hand part 105 or left-hand part 106 caused to make contact (step S109).

Next, mobile unit 100 measures the position of the contact target, using surrounding object recognition part 110, and determines whether or not the contact target has moved at least a constant distance (in other words, whether or not a clearance where mobile unit 100 can move has been made) based on a result of the measurement (step S110).

When the contact target has not moved at least a constant distance (step S110: NO), the flow returns to step S109. In this case, mobile unit 100 continues turning movement. Meanwhile, when the contact target has moved at least a constant distance (step S110: YES), mobile unit 100 ends prompting.

The details of the prompting method with respect to a contact target have been described thus far. Hereinafter, the description returns to the explanation of FIG. 4.

Next, mobile unit 100 starts moving to the destination again after lowering right-hand part 105 and left-hand part 106 (step S104).

Next, mobile unit 100 determines whether or not mobile unit 100 has arrived at the destination (step S105).

In a case where mobile unit 100 has not arrived at the destination (step S105: NO), the flow returns to step S101. In this case, mobile unit 100 moves to the destination in a state where right-hand part 105 and left-hand part 106 are kept lowered.

In a case where mobile unit 100 has arrived at the destination (step S105: YES), mobile unit 100 ends moving. That is, the flow of FIG. 4 is ended.

Note that, in step S101 and step S104, mobile unit 100 may move in a state where right-hand part 105 and left-hand part 106 are raised. In this case, the height of mobile unit 100 increases by the amount of raised parts of right-hand part 105 and left-hand part 106 compared with the case where mobile unit 100 moves in a state where right-hand part 105 and left-hand part 106 are lowered. Thus, it becomes easier to inform a human (contact target) around mobile unit 100 of the presence of mobile unit 100 and makes easier for a human to recognize mobile unit 100 in this case. Note that, in this case, prompting to a contact target is performed by lowering right-hand part 105 and left-hand part 106 in step S103.

As described above, according to mobile unit 100 of the present embodiment, the surface of mobile unit 100 includes an involute shape, and the center point of the involute shape passes through at least one axis among center axes of turning movement. Thus, the number of parts to be additionally mounted for promoting performed by making contact with a contact target (e.g., a human) can be reduced as much as possible, and it is made possible to suppress an increase in weight and/or costs of mobile unit 100 and also to suppress a decrease in reliability to the minimum.

The present invention is not limited to the description of the embodiment above and can be modified in various ways within a range not departing from the gist of the present invention. Hereinafter, each variation will be described.

[Variation 1]

For right driving section 102 and left driving section 103, crawlers may be used rather than wheels. Moreover, as a moving method of mobile unit 100 (body 101), moving may be performed using a leg mechanism rather than right driving section 102 and left driving section 103. In this case, moving on an uneven terrain such as an irregular surface can be easily performed compared with the case where wheels are used for right driving section 102 and left driving section 103.

[Variation 2]

As a moving method of mobile unit 100 (body 101), moving using an omnidirectional movement mechanism with an omni-wheel, rather than right driving section 102 and left driving section 103 may be performed. In this case, the degree of freedom in mobility increases compared with the case where wheels are used for right driving section 102 and left driving section 103, so that mobile performance can be enhanced.

[Variation 3]

Provision of at least one of right-hand part 105 and left-hand part 106 is sufficient. In this case, although contact in only one side direction is made, the number of configuration parts can be reduced.

[Variation 4]

As to shoulder parts 107, right-shoulder part 108 and left-shoulder part 109 may be configured to move independently. For example, a configuration may be employed in which an operation (e.g., raising or lowering operation) of only right-hand part 105 is made possible by turning only right-shoulder part 108. Likewise, a configuration may be employed in which an operation (e.g., raising or lowering operation) of only left-hand part 106 is made possible by turning only left-shoulder part 109.

In this case, in step S103 and step S104 of FIG. 4, a configuration may be employed in which an operation of only right-hand part 105 is performed by turning only right-shoulder part 108 when a contact target is present in the right direction of mobile unit 100, whereas an operation of only left-hand part 106 is performed by turning only left-shoulder part 109 when a contact target is present in the left direction of mobile unit 100. Thus, promoting with respect to a contact target can be performed even in a small space where it is difficult to simultaneously move both right-hand part 105 and left-hand part 106.

### SUMMARY OF THE PRESENT DISCLOSURE

A mobile unit of the present disclosure is capable of turning movement includes: an involute shape on an outer side surface of the mobile unit, in which a center point of a base circle of the involute shape passes through at least one axis among center axes of the turning movement.

Note that, the mobile unit of the present disclosure further includes: a plurality of driving sections that independently rotate on an identical rotation axis to perform the turning movement, in which the center point of the base circle of the involute shape may be on a plane passing through the identical rotation axis of the plurality of driving sections and being perpendicular to the ground.

Further, the mobile unit of the present disclosure further includes: arm parts extending from right and left positions in a width direction of the mobile unit, in which the arm parts may be combined at a center portion in the width direction of the mobile unit by hand parts provided in a forward direction of the arm parts, and an outer side of each of the arm parts may be the involute shape.

Further, the mobile unit of the present disclosure further includes: shoulder parts that turn the arm parts about a rotation shaft parallel to the width direction of the mobile unit, in which positions of the hand parts in a forward and backward direction and a height direction may be adjusted by the shoulder parts.

### INDUSTRIAL APPLICABILITY

A mobile unit of the present invention is useful in a situation where the mobile unit itself needs to make contact. The mobile unit of the present invention, for example, can be used during autonomous movement in a crowded environment or during movement while pushing a surrounding object.

### REFERENCE SIGNS LIST

100 Mobile unit
101 Body
102 Right-driving section
103 Left-driving section
104 Arm part
105 Right-hand part
106 Left-hand part
107 Shoulder part
110 Surrounding object recognition part

1. A mobile unit capable of turning movement, the mobile unit comprising:
an involute shape on an outer side surface of the mobile unit, wherein
a center point of a base circle of the involute shape passes through at least one axis among center axes of the turning movement.

2. The mobile unit according to claim 1, further comprising:
a plurality of driving sections that independently rotate on an identical rotation axis to perform the turning movement, wherein
the center point of the base circle of the involute shape is on a plane passing through the identical rotation axis of the plurality of driving sections and being perpendicular to the ground.

3. The mobile unit according to claim 1, further comprising:
arm parts extending from right and left positions in a width direction of the mobile unit, wherein
the arm parts are combined at a center portion in the width direction of the mobile unit by hand parts provided in a forward direction of the arm parts, and
an outer side of each of the arm parts is the involute shape.

4. The mobile unit according to claim 3, further comprising:
shoulder parts that turn the arm parts about a rotation shaft parallel to the width direction of the mobile unit, wherein
positions of the hand parts in a forward and backward direction and a height direction are adjusted by the shoulder parts.
